(19) United States
(12) Patent Application Publication
(10) Pub. No.: US 2014/0175934 A1
(43) Pub. Date: Jun. 26, 2014

(54) BRUSHLESS DC MOTOR OF AXIAL GAP TYPE

(71) Applicant: KOREA ELECTRONICS TECHNOLOGY INSTITUTE, Seongnam-si (KR)

(72) Inventors: Jeongjong LEE, Incheon (KR); Youngkyoun KIM, Seoul (KR); Sehyun RHYU, Bucheon-si (KR); Jungmoo SEO, Goyang-si (KR); Insoung JUNG, Seoul (KR)

(73) Assignee: KOREA ELECTRONICS TECHNOLOGY INSTITUTE, Seongnam-si (KR)

(21) Appl. No.: 14/026,572

(22) Filed: Sep. 13, 2013

(30) Foreign Application Priority Data
Dec. 24, 2012 (KR) 10-2012-0151691

(51) Int. Cl. H02K 3/46

(52) U.S. Cl. CPC H02K 3/46
USPC 310/208

(57) ABSTRACT

A brushless direct current (BLDC) motor of axial gap type includes a rotational axis, a stator rotatably connected to the rotational axis, a rotor disposed apart from the stator in an axial direction of the rotational axis, fixedly connected to the rotational axis, and including a permanent magnet formed on an inner surface thereof to face the stator. Further, the stator is formed as wiring board and includes a plate-like board body and a coil pattern. The board body is disposed in a horizontal position with regard to the rotor and has a central hole into which the rotational axis is inserted. The coil pattern is formed in the board body and arranged in a radial form around the central hole.

### TECHNICAL FIELD

The present disclosure relates to a brushless direct current (BLDC) motor and, more particularly, to an axial gap type BLDC motor in which a stator and a rotor are disposed to face each other in an axial direction of a rotational axis.

### BACKGROUND

Compared to a conventional DC motor having a brush, a BLDC motor does not have mechanical contact units such as a brush and a commutator, thus realizing higher performance, smaller, thinner and lighter structure, and longer lifespan. With the remarkable growths of semiconductor, component and material technologies, such BLDC motors are now widely used in various kinds of equipment, apparatus and devices. Normally BLDC motors are classified into a radial gap type and an axial gap type, and BLDC motors of radial gap type are further classified into an outer rotor type and an inner rotor type according to the disposition of a rotor having a permanent magnet.

In a radial gap type BLDC motor, a gap between a stator and a rotor is formed in a radial direction of a rotational axis. In contrast, an axial gap type BLDC motor has a gap formed in an axial direction of a rotational axis. Namely, in a BLDC motor of axial gap type, a rotor is disposed at one side or both sides of a stator along an axial direction. The former is referred to as one-sided type, and the latter is referred to as both-sided type.

Because of the advantage of a thin profile, such an axial gap type BLDC motor is used as a driving motor in a great variety of compact electronic devices.

This conventional BLDC motor of axial gap type has a permanent magnet and a coil which are disposed in an axial direction of a rotational axis. The permanent magnet is contained in the rotor, and the coil is contained in the stator. Further, the stator has a stator core to support the coil. With the coil and the permanent magnet disposed, a coil region forms a magnetic air gap.

Particularly, in case of both-sided type, coils are disposed between upper and lower permanent magnets, so that the operating point of the permanent magnet is lowered due to a relatively greater gap. Since this may cause the failure of the permanent magnet to show best performance, a way of winding the coil much more and reducing the diameter of the coil is used. This approach may, however, invite an undesirable increase in the resistance of the coil, resulting in a proportional rise in resistance loss. Therefore, a conventional BLDC motor of axial gap type has a limit to an improvement in efficiency.

### SUMMARY

Accordingly, one aspect of the present disclosure may provide an axial gap type BLDC motor in which the performance of a permanent magnet is enhanced due to a reduced gap and in which the efficiency is improved due to a reduced current.

Another aspect of the present disclosure may provide an axial gap type BLDC motor in which the thickness of a stator is reduced in an axial direction of a rotational axis through the elimination of coils from the exterior of a stator core.

An embodiment in this disclosure may provide a brushless direct current (BLDC) motor of axial gap type that comprises a rotational axis, a stator, and a rotor. The stator is rotatably connected to the rotational axis. The rotor is disposed apart from the stator in an axial direction of the rotational axis, is fixedly connected to the rotational axis, and includes a permanent magnet formed on an inner surface thereof to face the stator. Further, the stator is formed as wiring board and includes a plate-like board body disposed in a horizontal position with regard to the rotor and having a central hole into which the rotational axis is inserted, and a coil pattern formed in the board body and arranged in a radial form around the central hole.

In the axial gap type BLDC motor, the coil pattern may be embedded inside the board body.

In the axial gap type BLDC motor, the coil pattern may have a first coil pattern formed on a top surface of the board body, a second coil pattern connected to the first coil pattern and formed as one or more layers in the board body, and a third coil pattern connected to the second coil pattern and formed on a bottom surface of the board body.

In the axial gap type BLDC motor, the first, second and third coil patterns may be electrically connected to each other through at least one via hole.

In the axial gap type BLDC motor, the rotor may include a rotor plate fixed to the rotational axis, and the permanent magnet formed on a surface of the rotor plate in order to face the stator. The rotor may be disposed at either or both of upper and lower sides of the stator.

Another embodiment in this disclosure may provide a stator for an axial gap type brushless direct current (BLDC) motor that comprises a plate-like board body disposed in a horizontal position with regard to a rotor and having a central hole into which a rotational axis is inserted, and a coil pattern formed in the board body and arranged in a radial form around the central hole.

In the stator, the coil pattern may be embedded inside the board body.

In the stator, the coil pattern may include a first coil pattern formed on a top surface of the board body, a second coil pattern connected to the first coil pattern and formed as one or more layers in the board body, and a third coil pattern connected to the second coil pattern and formed on a bottom surface of the board body.

Since the stator has an embedded structure of the coil pattern in the board body, the axial gap type BLDC motor makes it possible to dispose the rotor near the stator. Therefore, the axial gap type BLDC motor can be manufactured in a smaller and thinner profile.

Additionally, since the stator is made as a kind of wiring board which has the coil pattern formed using circuit patterning technique in the board body, this can replace a conventional structure in which a coil is formed on a rotor core. It is therefore possible to reduce the thickness of the stator in an axial direction of the rotational axis. Further, the distance between the first and second permanent magnets disposed at both sides of the stator, namely the size of a gap between the permanent magnets, is reduced. Therefore, the performance of the first and second permanent magnets can be enhanced due to a reduced gap, and the efficiency can be improved due to a reduced current.

Meanwhile, the use of the coil pattern may unfavorably cause an increase in resistance in comparison with the use of a conventional coil. However, the use of the coil pattern may favorably increase the magnetic flux and thereby compensate for an increase in resistance, thus exerting similar performance in a small motor

Furthermore, the axial gap type BLDC motor does not require a conventional wiring process since the stator uses a wiring board having the coil pattern formed therein. Therefore, a manufacturing process can be simplified in comparison with a conventional BLDC motor of axial gap type.

### BRIEF DESCRIPTION OF THE DRAWINGS

FIG. 1 is a cross-sectional view illustrating a BLDC motor of axial gap type in accordance with the first embodiment of the present disclosure.

FIG. 2 is a plan view illustrating a stator shown in FIG. 1.

FIG. 3 is a cross-sectional view illustrating the comparison of a gap between a conventional axial gap type BLDC motor and an axial gap type BLDC motor in accordance with the first embodiment of the present disclosure.

FIG. 4 is a graph illustrating variations in the operating point of a permanent magnet between a conventional axial gap type BLDC motor and an axial gap type BLDC motor in accordance with the first embodiment of the present disclosure.

FIG. 5 is a cross-sectional view illustrating an axial gap type BLDC motor in accordance with the second embodiment of the present disclosure.

FIG. 6 is a cross-sectional view illustrating a stator of an axial gap type BLDC motor in accordance with the third embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a rotor” includes reference to one or more of such rotors.

### 1st Embodiment

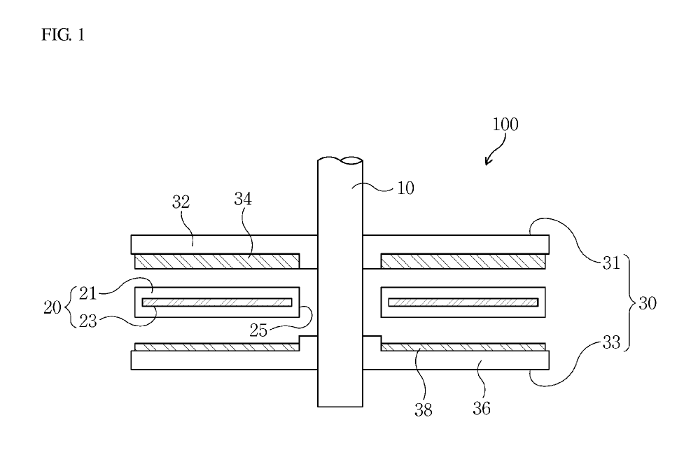

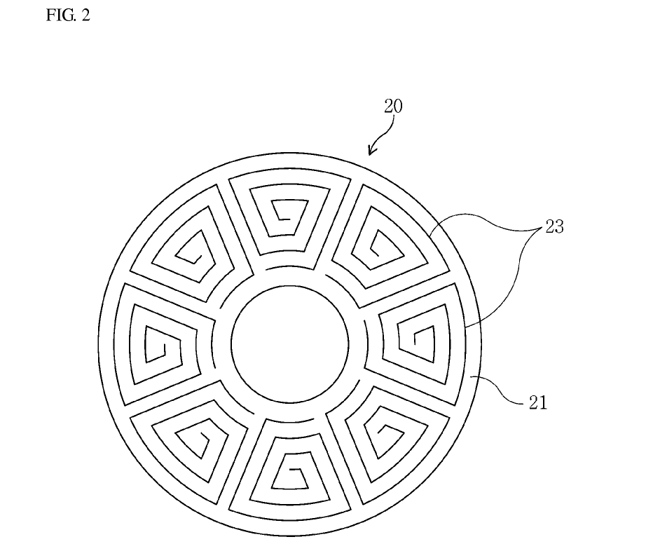

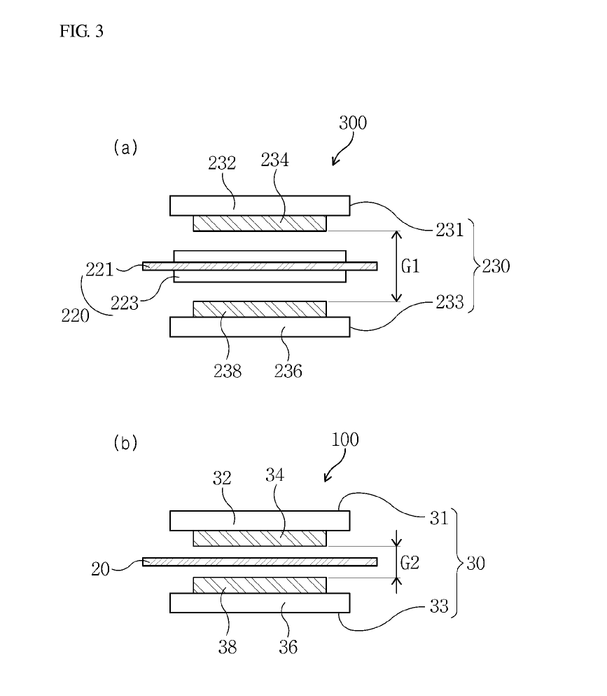

FIG. 1 is a cross-sectional view illustrating a BLDC motor 100 of axial gap type in accordance with the first embodiment of the present disclosure. FIG. 2 is a plan view illustrating a stator 20 shown in FIG. 1. FIG. 3 is a cross-sectional view illustrating the comparison of a gap between a conventional axial gap type BLDC motor 300 and an axial gap type BLDC motor 100 in accordance with the first embodiment of the present disclosure.

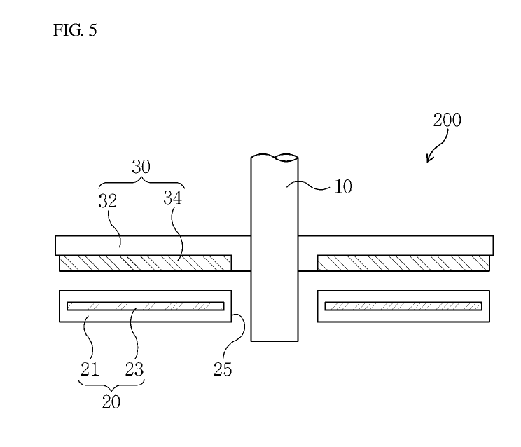

Referring to FIGS. 1 to 3, the axial gap type BLDC motor 100 in the first embodiment includes the rotational axis 10, the stator 20 and the rotor 30. Particularly, the axial gap type BLDC motor 100 in the first embodiment is both-sided type in which a rotor 30 is disposed at both sides of a stator 20 in an axial direction of a rotational axis 10. This is, however, exemplary only and not to be considered as a limitation of embodiments. Alternatively, the axial gap type BLDC motor may be formed as single-sided type, which will be described below with reference FIG. 5.

The stator 20 and the rotor 30 are disposed at intervals in an axial direction of the rotational axis 10. The rotational axis 10 is rotatably connected to the stator 20 and fixedly connected to the rotor 30. The stator 20 has a coil pattern 23 embedded therein, and the rotor 30 has permanent magnets 34 and 38 formed on the inner surface thereof to face the stator 20. Particularly, the stator 20 is a kind of wiring board and includes a plate-like board body 21 and the coil pattern 23. The board body 21 is in a horizontal position with regard to the rotor 30 and has a central hole 25 into which the rotational axis 10 is inserted. The coil pattern 23 is embedded in the board body 21 and arranged in a radial form around the central hole 25.

Now, the axial gap type BLDC motor 100 in the first embodiment will be more fully described.

The stator 20 can be formed as a wiring board which includes the board body 21 and the coil pattern 23. A wiring board may be, but not limited to, a rigid type printed circuit board.

The board body 21 may be made of any insulting material such as rigid plastic or ceramic The board body 21 is shaped like a circular plate and has the central hole 25. The rotational axis 10 is inserted into and partially located in the central hole 25. The diameter of the central hole 25 is greater than that of the rotational axis 10, so that the rotational axis 10 is spaced apart from the inner sidewall of the central hole 25.

The coil pattern 23 is formed of a patterned copper layer and is embedded inside the board body 21 which may have a multi-layered structure. The coil pattern 23 may be arranged in a radial form around the central hole 25, i.e., around the rotational axis 10.

The stator 20 may be rotatably coupled to the rotational axis 10 by means of a bearing. Additionally or alternatively, the stator 20 may be fixed to any kind of casing, shell, housing, or other equivalent which covers the stator 20 or the motor 100.

The rotor 30 includes the first (i.e., upper) rotor 31 and the second (i.e., lower) rotor 33 which are disposed at upper and lower sides of the stator 20, respectively. The first rotor 31 has the first rotor plate 32 fixed to the rotational axis 10, and the first permanent magnet 34 formed on a surface of the first rotor plate 32 to face the stator 20. Similarly, the second rotor 33 has the second rotor plate 36 fixed to the rotational axis 10, and the second permanent magnet 38 formed on a surface of the second rotor plate 36 to face the stator 20. Namely, the first and second permanent magnets 34 and 38 face each other, being disposed at and spaced apart from both sides of the stator 20. The first and second rotor plate 32 and 36 may be formed of metal such as iron.

Since the stator 20 has an embedded structure of the coil pattern 23 in the board body 21, the axial gap type BLDC motor 100 in the first embodiment makes it possible to dispose the rotor 30 near the stator 20. Therefore, the axial gap type BLDC motor 100 in the first embodiment can be manufactured in a smaller and thinner profile.

Additionally, since the stator 20 is made as a kind of wiring board which has the coil pattern 23 formed using circuit patterning technique in the board body 21, this can replace a conventional structure in which a coil is formed on a rotor core. It is therefore possible to reduce the thickness of the stator 20 in an axial direction of the rotational axis 10. Further, as shown in FIG. 3, the distance between the first and second permanent magnets 34 and 38 disposed at both sides of the stator 20, namely the size of a gap G2 between the permanent magnets 34 and 38, is reduced in comparison with the size of a conventional gap G1. Therefore, the performance of the first and second permanent magnets 34 and 38 can be enhanced due to a reduced gap, and the efficiency can be improved due to a reduced current.

Namely, as shown in FIG. 3 (a), a conventional stator 220 has a structure in which a coil 223 is wound on a stator core 221, so that the size of a gap G1 between both permanent magnets 234 and 238 of upper and lower rotors 231 and 233 is greater than that of a gap G2 shown in FIG. 3 (b).

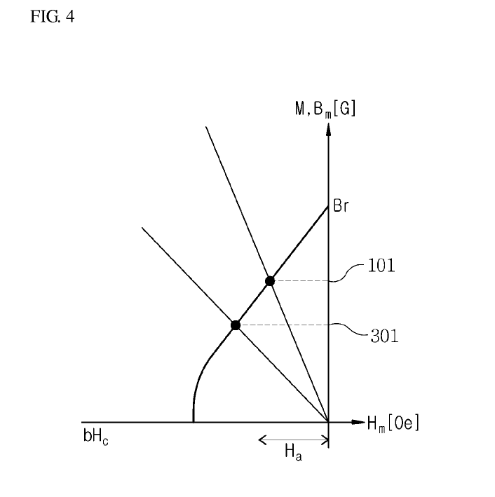

Meanwhile, the use of the coil pattern 23 may unfavorably cause an increase in resistance in comparison with the use of a conventional coil. However, the use of the coil pattern 23 may favorably increase the magnetic flux and thereby compensate for an increase in resistance, thus exerting similar performance in a small motor. This can be verified from a graph shown in FIG. 4.

FIG. 4 is a graph illustrating variations in the operating point of a permanent magnet between a axial gap type conventional BLDC motor and an axial gap type BLDC motor in accordance with the first embodiment of the present disclosure. Referring to FIG. 4, the operating points 101 and 301 of permanent magnets indicate the amount of output at residual magnetic flux density (Br) which is one of basic characteristics of the permanent magnet. Namely, the operating points 101 and 301 are defined as specific points when the size of magnetic flux generated from the permanent magnet is varied due to a certain object. In the first embodiment discussed hereinbefore, a reduction in a gap resulting from the use of the embedded coil pattern increases the operating point 101 in comparison with a conventional operating point 301. This not only increases the intensity of the permanent magnet, but also reduces an electric current. As a result, an improvement in efficiency can be attained.

Furthermore, the axial gap type BLDC motor 100 in the first embodiment does not require a conventional wiring process since the stator 20 uses a wiring board having the coil pattern 23 formed therein. Therefore, a manufacturing process can be simplified in comparison with a conventional BLDC motor of axial gap type.

Moreover, the axial gap type BLDC motor 100 in the first embodiment has a simple structure suitable for mass production. Particularly, a smaller and thinner structure resulting from the use of a wiring board having the embedded coil pattern 23 may be favorably applied to various kinds of electronic devices that require a small motor.

### 2nd Embodiment

Contrary to the above-discussed first embodiment in which the first and second rotors 31 and 33 are disposed at both sides of the stator 20, the rotor 30 may be disposed at only one side of the stator 20 as described below and shown in FIG. 5.

FIG. 5 is a cross-sectional view illustrating an axial gap type BLDC motor 200 in accordance with the second embodiment of the present disclosure.

Referring to FIG. 5, the axial gap type BLDC motor 200 in the second embodiment is one-sided type in which the rotor 30 is disposed at only one side of the stator 20 in an axial direction of the rotational axis 10. As discussed above in the first embodiment, the axial gap type BLDC motor 200 in the second embodiment includes the rotational axis 10, the stator 20 and the rotor 30.

The stator 20 in the second embodiment is identical with the above-discussed stator of the first embodiment in that the coil pattern 23 is formed in the board body 21. Therefore, the axial gap type BLDC motor 200 in the second embodiment is equal or similar in effects to the above-discussed BLDC motor (100 in FIG. 1) in the first embodiment.

### 3rd Embodiment

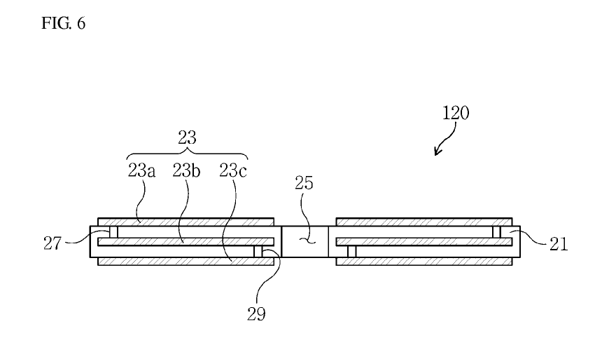

Contrary to the above-discussed first embodiment in which the stator 20 has the coil pattern 23 embedded in the board body 21, the coil pattern 23 may be further formed on at least one of upper and lower surfaces of the board body 21 as described below and shown in FIG. 6.

FIG. 6 is a cross-sectional view illustrating a stator 120 of an axial gap type BLDC motor in accordance with the third embodiment of the present disclosure.

Referring to FIG. 6, the stator 120 of the axial gap type BLDC motor in the third embodiment includes the board body 21 and the coil pattern 23.

The board body 21 is shaped like a circular plate and has the central hole 25.

The coil pattern 23 may include the first, second and third coil patterns 23a, 23b and 23c. The first coil pattern 23a is formed on the top surface of the board body 21. The second coil pattern 23b is connected to the first coil pattern 23a and formed as one or more layers in the board body 21. The third coil pattern 23c is connected to the second coil pattern 23b and formed on the bottom surface of the board body 21.

The first and second coil patterns 23a and 23b are electrically connected to each other through the first via hole 27. Similarly, the second and third coil patterns 23b and 23c are electrically connected to each other through the second via hole 29.

Although in the third embodiment the coil pattern 23 is formed on and in the board body 21, this is exemplary only and not to be considered as a limitation. Alternatively, the coil pattern 23 may be formed selectively on and/or in the board body 21.

Additionally, although in the third embodiment the first via hole 27 connects the first and second coil patterns 23a and 23b and the second via hole 29 connects the second and third coil patterns 23b and 23c, this is exemplary only and not to be considered as a limitation. Alternatively, a via hole that entirely passes through the board body 21 may connect all of the first, second and third coil patterns 23a, 23b and 23c.

While this disclosure has been particularly shown and described with reference to an exemplary embodiment thereof, it will be understood by those skilled in the art that various changes in form and details may be made therein without departing from the spirit and scope of this disclosure as defined by the appended claims.

What is claimed is:

1. A brushless direct current (BLDC) motor of axial gap type, comprising:
a rotational axis;
a stator rotatably connected to the rotational axis; and
a rotor disposed apart from the stator in an axial direction of the rotational axis, fixedly connected to the rotational axis, and including a permanent magnet formed on an inner surface thereof to face the stator,
wherein the stator is formed as wiring board and includes:
a plate-like board body disposed in a horizontal position with regard to the rotor and having a central hole into which the rotational axis is inserted; and
a coil pattern formed in the board body and arranged in a radial form around the central hole.

2. The axial gap type BLDC motor of claim 1, wherein the coil pattern is embedded inside the board body.

3. The axial gap type BLDC motor of claim 1, wherein the coil pattern has:
a first coil pattern formed on a top surface of the board body;
a second coil pattern connected to the first coil pattern and formed as one or more layers in the board body; and
a third coil pattern connected to the second coil pattern and formed on a bottom surface of the board body.

4. The axial gap type BLDC motor of claim 3, wherein the first, second and third coil patterns are electrically connected to each other through at least one via hole.

5. The axial gap type BLDC motor of claim 1, wherein the rotor includes:
a rotor plate fixed to the rotational axis; and
the permanent magnet formed on a surface of the rotor plate in order to face the stator,
wherein the rotor is disposed at either or both of upper and lower sides of the stator.

6. A stator for an axial gap type brushless direct current (BLDC) motor, comprising:
a plate-like board body disposed in a horizontal position with regard to a rotor and having a central hole into which a rotational axis is inserted; and
a coil pattern formed in the board body and arranged in a radial form around the central hole.

7. The stator of claim 6, wherein the coil pattern is embedded inside the board body.

8. The stator of claim 6, wherein the coil pattern includes:
a first coil pattern formed on a top surface of the board body;
a second coil pattern connected to the first coil pattern and formed as one or more layers in the board body; and
a third coil pattern connected to the second coil pattern and formed on a bottom surface of the board body.
